(19) United States
(12) Patent Application Publication
(10) Pub. No.: US 2022/0012835 A1
(43) Pub. Date: Jan. 13, 2022

(54) ALL-IN-ONE HOMELESS CARE AND REHAB FACILITY

(71) Applicant: Ronald S Housman, Harbor City, CA (US)

(72) Inventor: Ronald S Housman, Harbor City, CA (US)

(21) Appl. No.: 16/927,889

(22) Filed: Jul. 13, 2020

(51) Int. Cl. G06Q 50/22; E04H 1/00; E04H 15/18; E04H 1/02

(52) U.S. Cl. CPC G06Q 50/22; E04H 1/02; E04H 15/18; E04H 1/005

(57) ABSTRACT

A system and method for providing an All-in-One Homeless Care and Rehabilitation Facility is disclosed. This facility provides spaces to address the initial need to provide living space for its residents including living space, meals, showers and bathroom accommodations, and the needed infrastructure to operate. The facility will provide basic minor health care on-site rehabilitative care for the those addicted to drugs and alcohol; including on-site psychological counseling and prescription medicines as proscribed for the needs affecting the homeless. Any one that exhibits ill health after admission, will be referred to 911 services, on their own, or by Staff. Lastly, the facilities provide services to address social issues that also prevent the members of this population from obtaining a job, securing a place to live, and otherwise provide for themselves. The social services include treatment for substance abuse problems, and any additional education and training needed by the residents. The present invention includes facilities and services to address all of these needs in a single, temporary location that addresses all of the existing limitations for existing facilities providing services to homeless individuals.

### TECHNICAL FIELD

This application relates in general to a method for providing homeless care and support as part of physical and psychological rehabilitation, and more specifically, to a method for providing an all-in-one temporary homeless care and rehabilitation facility.

### BACKGROUND

Homelessness is a problem facing many communities, both urban as well as rural communities, that present a need to assist the homeless population transition to re-entering communities as self-sufficient members. The need for a facility to assist these individuals may arise at one location due to long term economic conditions and may arise at another location due to natural environmental events and emergencies. In most cases, such a facility needs to be able to address all of the medical, physical, psychological, and social issues that are currently preventing this population from living and providing for themselves financially.

Such a facility may need to exist for a short period of time in one set of circumstances and may require a longer term for other circumstances. In most cases, each facility may need to address the medical, physical, psychological, and social issues of its population. Currently, emergency management organizations may provide for temporary shelter facilities and related services at times following a natural disaster; however, no such facilities provide all of the materials, staffing, and support services needed to address the medical, physical, psychological, and social issues present in most homeless populations. One group of emergency facilities may provide housing and meals. Another group of facilities may provide acute medical care services. However, no existing facilities provide all of the required services and materials to assist most homeless populations successfully transition from their existing circumstances to an end goal of financial self-sufficiency.

Therefore, a need exists for a method for providing an all-in-one homeless care and rehabilitation facility. This facility needs to address the initial need to provide living space for its residents including living space, meals, showers and bathroom accommodations, and the needed infrastructure to operate. Prior to entering the facility, local County social, or other health workers, will refer members to 911, to be sure they are healthy enough to enter the temporary facility envisioned herein The main goal of the center is to provide immediate clean, safe, and drug free housing, so as to allow rehabilitation and recovery of the addicted and mentally ill. The center will be designed and focused upon rehabilitating the non-chronically ill, who can be rehabilitated for potential employability in 12-18 months. This rehabilitative care will address minor physical illnesses, mental health issues and drug and alcohol addiction inflicting the homeless population.

These facilities will also address social issues that also prevent the members of this population from obtaining a job, securing a place to live, and otherwise provide for themselves. For example, some residents of a facility may require treatment for substance abuse problems, while other residents require additional education and training. The present invention includes facilities and services to address all of these needs in a single, temporary location that addresses all of the existing limitations for existing facilities providing services to homeless individuals.

### SUMMARY

In accordance with the present invention, the above and other problems are solved by providing a method for providing an all-in-one temporary care for the homeless, and rehabilitation facility according to the principles and example embodiments disclosed herein.

In an embodiment, the present invention is a method for providing temporary care for the homeless and support as part of physical and psychological rehabilitation, and more specifically a method for providing an all-in-one homeless care and rehabilitation facility to allow the individual to be employable in the labor market.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other methods for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates a sequence of configurations for setting up an All-in-One Homeless Care and Rehabilitation Facility according to the present invention.

FIG. 2 illustrates an example embodiment for a facility that provides a method for providing all-in-one homeless care and rehabilitation according to the present invention.

FIG. 3 illustrates another example embodiment of an individual living space provided to individuals within a facility used in a method for providing homeless care and support as part of physical and psychological rehabilitation according to the present invention.

FIG. 4 illustrates a flowchart corresponding to a method for providing homeless care and support as part of physical and psychological rehabilitation according to the present invention.

### DETAILED DESCRIPTION

This application relates in general a method for providing temporary homeless care and support and more specifically, to a method for providing an all-in-one homeless care and rehabilitation facility according to the present invention.

An embodiment of the present invention will be described in detail with reference to the drawings, wherein like reference numerals represent like parts and steps throughout the several views. Reference to this embodiment does not limit the scope of the invention, which is limited only by the scope of the claims attached hereto. Additionally, any examples set forth in this specification are not intended to be limiting and merely set forth some of the many possible embodiments for the claimed invention.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “client,” and “user” refer to an entity, e.g. a human, using the All-in-One Homeless Care and Rehabilitation Facility associated with the invention. The term user herein refers to one or more users.

The term “invention” or “present invention” refers to the invention being applied for via the patent application with the title “All-in-One Homeless Care and Rehabilitation Facility.” Invention may be used interchangeably with “facility.”

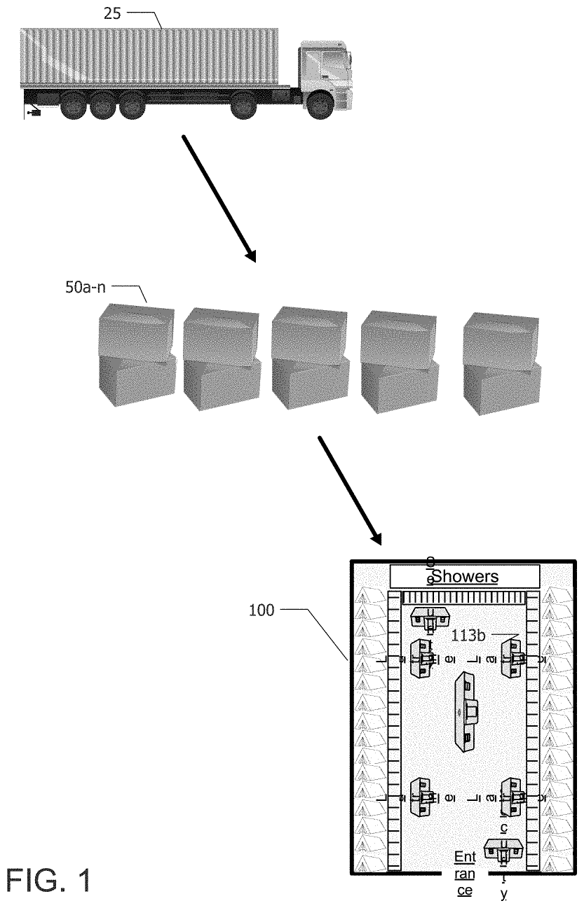

In general, the present disclosure relates a method for providing homeless care and support as part of physical and psychological rehabilitation and more specifically, to a method for providing an all-in-one homeless care and rehabilitation facility. To better understand the present invention, FIG. 1 illustrates a sequence of configurations for setting up an All-in-One Homeless Care and Rehabilitation Facility of up to 100 according to the present invention. To address the needs of homeless populations as circumstances change, facilities that provide needed services to these populations may typically need to be available in locations that vary over time depending upon circumstances giving rise to the need for services. As such, creating a facility that provides All-in-One Homeless Care and Rehabilitation services may be viewed as having a limited lifespan while the services are most needed. The All-in-One Homeless Care and Rehabilitation Facility of up to 100 is a semi-mobile and temporary facility which may be transported to a location using a number of trucks 25 that bring a predefined set of material packed into creates and boxes 50a-n. These crates 50a-n may be unpacked when delivered to a location and set up according to a predefined design creating the facility of up to 100.

The preconfigured and predesigned set of materials may be stored as a single collection of items that may be moved and set up when needed. The facility of up to 100 may be staffed by a group of individuals and service providers who are activated when needed much the way that other governmental aid organizations such as the National Guard and Federal Emergency Management Agency (FEMA) operate in times of need. All of the items needed to create a working facility are included in the crates 50a-n from tents to provide shelter, infrastructure to provide shelter, hot and cold water, showers, and support. The facility will typically maintain “ready to eat” meals for lunch and dinner for the residents. The residents will be able to leave the center to get lunch. Various non-profit ministries and/or other volunteer organizations may bring lunch into the center when arranged in advance]. A fully functional and operating facility of up to 100 may be created using the transported materials without need for obtaining additional items.

The present invention includes the set of materials used to set up the working facility of up to 100, the set of support staff required to operate the facility of up to 100 and provide any needed services, and an initial supply of consumable items such as food, blankets, and similar items that will be needed immediately to begin accepting individuals requiring the provided services. By preconfiguring such a facility, stockpiling the needed supplies, organizing everything into a complete package, and arranging for delivery and set up of a facility at temporary location, an All-in-One Homeless Care and Rehabilitation Facility of up to 100 is quickly and uniformly created when circumstances arise

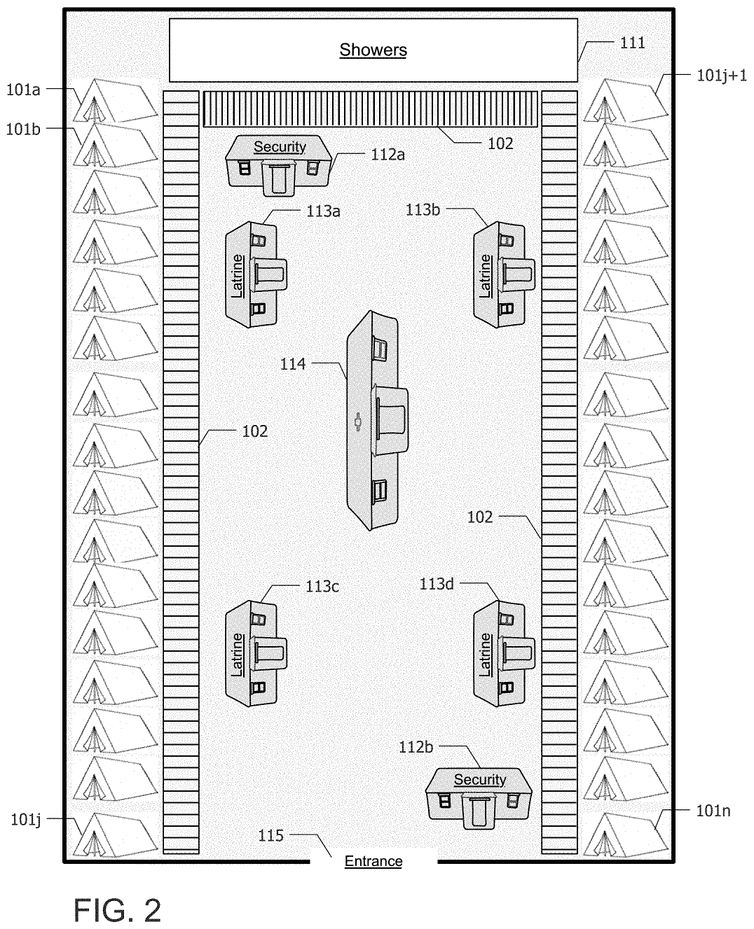

FIG. 2 illustrates an example embodiment for a facility that provides a method for homeless care and support as part of physical and psychological rehabilitation according to the present invention.

The facility 100 provides its residents with housing and related living accommodations, minor health, mental health, and job training services. The housing includes high-quality, heavy-duty, military-grade tents with at least one bed, one dresser, one table, a heater, portable A/C, and a-storage unit. The tent is to provide each resident with his/her own private living space In some initial embodiments, the center may not be able to handle family units. These centers are intended to provide support to the homeless, addicted, and needy only individuals only. The community will comprise high-quality portable latrines and showers, laundry facilities, a drug-free living environment with a 24-hr armed security service to ensure safety for all residents, and one or more large multi-purpose, communal tents. The tents provide climate-controlled meeting space, job training with outside consultants, recreational activities, multi-denominational worship services, healthcare/medical services, daycare, meal service, educational and job-training related services with state-of-the art computers, and the like. Busses may be included in the facility's materials to provide transportation to its residents as they progress from any initial set of needs to an ability of live and function in permanent living arrangements while holding down a job providing self-sufficiency.

The entire facility of up to 100 is purposed on public vacant land. Any construction is modular for easy transfer to and between available sites. All sites are self-sustaining with solar panels and generators. Accommodations are available for single individuals. Residency is temporary and is expected for 12-18 months, to allow for rehabilitation, training, and/or retraining.

If County resources are limited, residents may be provided an initial screening upon their arrival at the facility to determine whether the residents are healthy enough and appropriate clients for receiving services. For residents determined to be healthy enough to use center/services, the residents are provided on-site outpatient mental health and substance-abuse rehab services. In urban areas with large medical centers, an on-site physician may coordinate volunteer services provided by local medical and dental school students for school credit. All residents are required to sign releases that they and their guests agree to remain drug/alcohol free.

The facility typically will not provide on-site physical care, beyond common sense observation and calling 911 if needed. Prescriptions medications may be dispensed, per the doctor/psychiatrist orders on a 1-per week basis. The facility staff may pick up these medications from the pharmacy and deliver directly to the resident. No drugs or medications will be kept on site. No monitoring of medications will be undertaken. This facility is being designed as “out-patient” facility, where the patients undertake all instructions on their own at home, until they again see their rehab provider.

The job training services include training as determined to be needed for each resident at in-take. After residents are drug/alcohol free for at least 60 days, provide them with access to job training with local trades and professional service companies. All facilities partner with private and public sectors to secure temporary subsidies for center graduates' initial hourly rate. The facility will typically provide residents with access to state of the art job trainers, job programs, and/or webinars, in a multitude of fields, from which they can select; once they are sober and healthy. The facility is not intended to be a school. The services provide rapid job training skills for low skilled individuals, to render them able to get a basic job, income, and advance upward once they are out of the center. Most of the residents may have had skills prior to their descent into addiction.

The facility is a self-contained location having a plurality of resident tents 101a-n for providing individual living quarters for the residents. The facility includes a set of communal showers 111 and multiple latrines 111a-d to support the residents. Accommodations will be made to support all genders in these communal facilities. Facilities use US-military style tents and modular construction techniques to provide safe, adequate long-term living environments in an affordable and non-permanent state. The specific requirements for these facilities may be tailored to match local weather and zoning requirements.

Security is provided by a common entrance 115 and multiple security stations 112a-b as needed to support the on-site security staff. The entire facility is enclosed perimeter fencing to provide protection for the residents from outside individuals. A covered walkway 102 will connect all residents' tents to the common facilities to provide suitable protection from the environment. Lighting throughout the facility will be provided to support security efforts while not interfering with residents' activities and sleep. Any common areas may be grass, sand or man-made weather resistant surfaces that provide suitable drainage as needed.

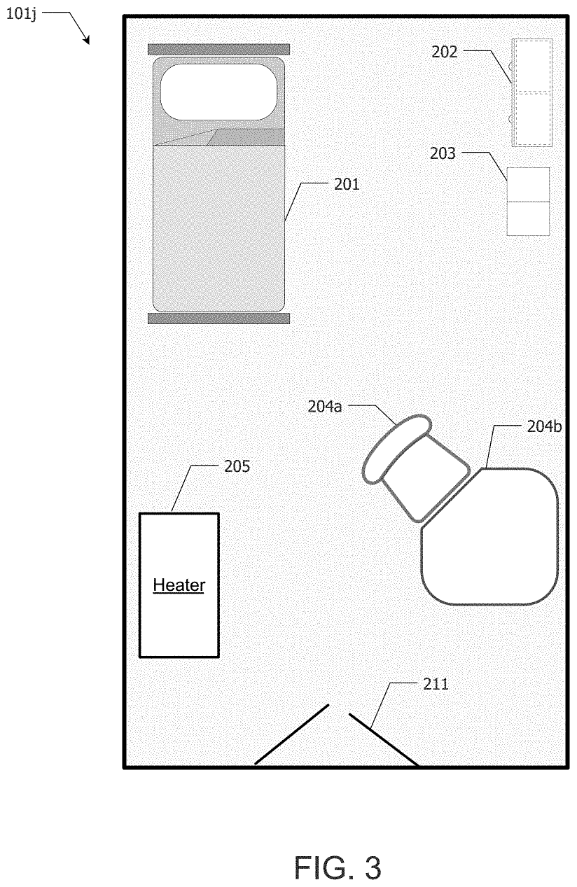

FIG. 3 illustrates another example embodiment of an individual living space within a facility used in a method for providing homeless care and support and more specifically, to a method for providing an all-in-one homeless care and rehabilitation facility according to the present invention. A single bed 201 is shown for a single resident tent 101j. The tent for one individual is typically an 8×10 foot enclosure that provides space to change, sleep, read, rest and generally live when not in any communal activities. The space will include a heater 205 for colder weather, and portable A/C unit. A table/desk 204b and a chair 204a are also provide for use by a resident. Storage for personal items is provided in a dresser/cabinet 202 and an end table 203. Multiple beds, larger tables and multiple chairs, and additional storage items may also be included as needed.

Portable lighting inside all of the tents will be provided. Typically the facility will be able to provide battery operated lamps for nighttime lighting. If family members want to bring the residents with additional items, including mobile phones, some additional assistance will be provided. Access to phones at the Manager's office will be available for emergencies. Email for communicating with outside entities, especially as part of job training and job placement activities may be supported by cell phones or similar devices that connect to a communal WiFi network to obtain access to the Internet. Residents may access computers in the multi-purpose tent, when training is active. Otherwise that equipment will be locked and secure. Each resident will have a in-tent locked storage cabinet for valuables. Anything that does not fit in the cabinet will have to be discarded; or other arrangements made by the resident when sober. Basic clothing will be provided if they have none, pants, shirts, tops only.

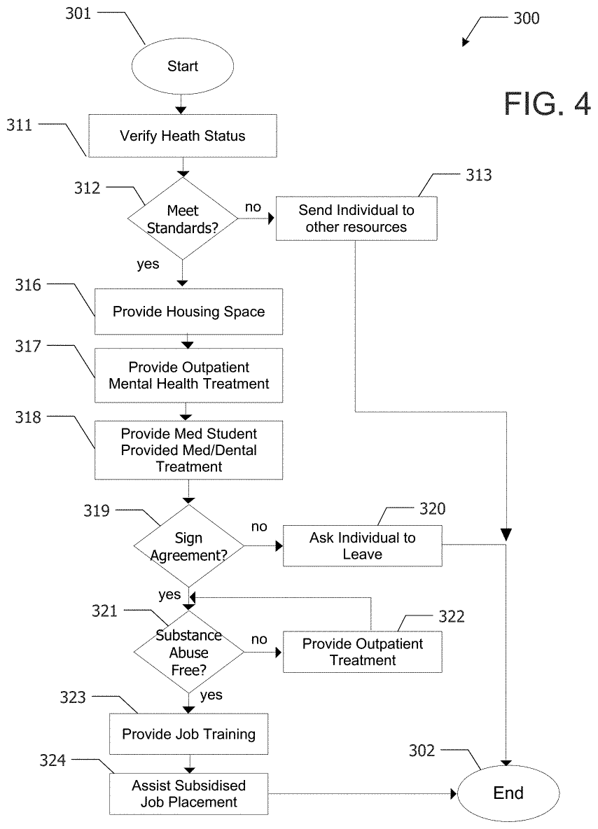

FIG. 4 illustrates a flowchart corresponding to a method for providing homeless care and support as part of physical and psychological rehabilitation and more specifically, for providing an all-in-one homeless care and rehabilitation facility according to the present invention. The in-take process begins 301 when a resident enters or is referred to a facility by local human services officials. If County resources are limited, an incoming resident is initially given triage to determine if they meet the minimum requirements for entry into the facility in step 311. In most cases, residents are expected to be referred to the facility by other professionals such as by the police, social workers, and other government workers who “recommend” the center. Generally, the residents are healthy enough not to be sent to an ER, they may come to the Center. The “triage” typically takes place before they reach the center.

Test step 312 determine if the incoming resident meets the entry requirements of the facility, and if not the resident is referred to another facility on step 313 and the process ends. Once an incoming resident is ready for acceptance into the facility, appropriate housing space is made available in step 316. All residents are provided ongoing outpatient mental health and addiction treatment in step 317. This mental health treatment may be provided by psychiatrists if medication is required, by various counselors for individual and group treatment, and by resident-run support groups in daily meetings such as the ones provided in 12-step programs. All programs used will be designed as a “out-patient” program. Rather than have the residents go the professionals and back; the professionals will go to and from the center. It is designed as an on-site, out-patient rehab program.

Basic health checks, and dental care may be provided to all residents in step 318, through cooperative agreements with local medical and/or dental schools. Local medical schools and dental schools may provide care as part of the schools training to new practitioners when they are sufficiently trained to care for individuals. This treatment may be provided, if appropriate, in common spaces in the facility. Transportation may also be provided to the local bus or train system. No individual shuttling beyond giving them access to public transportation will be provided.

Once a resident has been accepted and placed into the facility, the resident is asked to sign a release and agreement in which the resident accepts any rules to be followed in the facility, any expectations for efforts expected from the resident, and an express agreement to remain alcohol and drug free while remaining in the facility. Test step 319 determines whether the resident agrees to these terms and executes the release agreement. If the resident does not agree to the terms and execute the agreement, the resident is asked to leave the facility in step 320 and the process 302 ends for the resident.

If the resident executes the agreement, test step 321 determines whether the resident is remaining drug and alcohol free, and if not, additional outpatient treatment is provided in step 322 until the resident obtains a level of sobriety. Once sober, the resident is provided job training in step 323 as needed which will lead to job placement in step 324. These efforts continue until the resident has become sufficiently self-sufficient to obtain living arrangements outside of the facility at which time the process ends 302. It is envisioned this process will take 12-18 months.

Even though a particular combination of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed:

1. A method for providing temporary care for the homeless and support as part of physical and psychological rehabilitation, and more specifically, to a method for providing an all-in-one homeless care and rehabilitation facility, the method comprising:
verifying an incoming resident meets a minimum health status;
when the incoming resident meets the minimum health status, assign the incoming resident to a resident status;
providing housing space to the residents using temporary shelter deployed as needed;
providing outpatient mental health and drug rehabilitation treatment to the residents;
providing student provided medical and dental care under supervision of authorized university faculty;
requesting incoming resident to agree to and execute a facility behavior agreement;
if the incoming resident refuses to execute the facility behavior agreement, ending the resident stay at the all-in-one homeless care and rehabilitation facility;
when the residents are not free from substance abuse, providing out-patient addiction treatment;
providing job training to the residents; and
assisting the residents to obtain job placement;
wherein the all-in-one homeless care and rehabilitation facility is temporarily constructed on unused public lands.

2. The method according to claim 1, wherein the housing is provided to the residents in one person per tent arrangements.

3. The method according to claim 2, wherein the housing provides battery operated lighting in the one person tents.

4. The method according to claim 1, wherein the all-in-one homeless care and rehabilitation facility comprises:
a plurality of temporary rest room facilities;
one or more climate controlled meeting spaces; and
one or more security facilities.

5. The method according to claim 4, wherein the temporary rest room facilities comprise a plurality of latrines and one or more communal showers.

6. The method according to claim 4, wherein the all-in-one homeless care and rehabilitation facility further comprises one or more communal computing devices for use in treatment, training and job placement during supervised hours.

7. The method according to claim 6, wherein the all-in-one homeless care and rehabilitation facility further comprises a manager office with communications facilities.

8. The method according to claim 4, wherein the method further comprises providing transportation to and from a local bus, train, and subway system.

9. The method according to claim 1, wherein the method further comprising ending the resident stay at the all-in-one homeless care and rehabilitation facility when they violate the facility behavior agreement.

10. The method according to claim 1, wherein the residents are provided housing and services for between 12 and 18 months.
